(19) United States
(12) Patent Application Publication
(10) Pub. No.: US 2005/0055664 A1
(43) Pub. Date: Mar. 10, 2005

(54) Notification spheres in workflow management systems

(75) Inventors: Matthias Kloppmann, Sindelfingen (DE); Frank Leymann, Aidlingen (DE); Dieter Roller, Schoenaich (DE)

Correspondence Address: International Business Machines;Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/880,261

(22) Filed: Jun. 29, 2004

(30) Foreign Application Priority Data
Sep. 5, 2003 (EP) 03103304.6

(51) Int. Cl. G06F 17/60

(52) U.S. Cl. 717/100

(57) ABSTRACT

The current invention relates to a technology for handling of notifications within a Workflow Management System or a computer system with comparable functionality (WFMS). WFMS control the execution of an instance of a process-model with activities as well as rules defining a potential control-flow within the process-model. The method comprises a step of determining if the process-model comprises a specification defining a notification-sphere. The notification-sphere, which comprises a multitude of activities representing a proper subset of activities of the process model is associated with at least one predefined notification-condition, specifying a condition under which a notification is to be sent on behalf of the subset of activities. A step of starting monitoring the notification-condition is comprised once the control-flow enters the notification-sphere a first time. In a further step a notification is sent once said notification-condition is fulfilled on behalf of the activities comprised by the notification-sphere.

### 1. BACKGROUND OF THE INVENTION

1.1 Field of the Invention

The present invention relates to means and a method for handling of notifications within a Workflow Management System or a computer system with comparable functionality (WFMS).

1.2 Description and Disadvantages of Prior Art

A new area of technology with increasing importance is the domain of Workflow-Management-Systems (WFMS). WFMS support the modelling and execution of business processes. Business processes executed within a WFMS environment control who will perform which piece of work of a network of pieces of work and which resources are exploited for this work. The individual pieces of work might be distributed across a multitude of different computer systems connected by some type of network.

The product “IBM MQSeries Workflow” (previously called IBM FlowMark) represents such a typical modern, sophisticated, and powerful workflow management system. It supports the modelling of business processes as a network of activities. This network of activities, the process model, is constructed as a directed, acyclic, weighted, colored graph. The nodes of the graph represent the activities, which define the individual tasks that need to be carried out. In general, each of the activities is associated with a piece of code that implements the appropriate task. The edges of the graph, the control connectors, describe the potential sequence of execution of the activities. Definition of the process graph is via IBM MQSeries Workflow's Flow Definition Language (FDL) or via the built-in graphical editor.

It is important that the business processes as a whole as well as the individual activities are carried out within certain time constraints and that appropriate actions are taken if the specified time constraints are exceeded. Thus the workflow management system must provide improved capabilities for specifying and handling of such time constraints.

1.3 Objective of the Invention

The invention is based on the objective to improve the specification and handling of times constraints associated with process models of business processes.

### 2. SUMMARY AND ADVANTAGES OF THE INVENTION

The objectives of the invention are solved by the independent claims. Further advantageous arrangements and embodiments of the invention are set forth in the respective subclaims.

The current invention relates to a method and to a system for handling of notifications within a Workflow Management System or a computer system with comparable functionality (WFMS). WFMS control the execution of a process-instance by interpreting the instance of a process model of a business process. Such a process model comprises a multitude of activities as well as rules defining a potential control flow within the process model. In one optional approach such a process model is realized by representing the multitude of activities as nodes of an arbitrary graph and directed edges of said graph are defining a potential control flow within the process model; i.e. above mentioned rules are realized as directed edges within the graph.

The method comprises a step of determining if the process model comprises a specification defining a notification sphere. The notification sphere, which comprises a multitude of activities representing a proper subset of activities of the process model, is associated with at least one predefined notification condition, specifying a condition under which a notification is to be sent on behalf of activities comprised by the subset of activities. A step of starting monitoring the notification condition is comprised once the control flow enters the notification sphere a first time. In a further step a notification is sent once said notification condition is fulfilled on behalf of the activities comprised by the notification sphere.

The suggested approach improves significantly the techniques for specifying and monitoring the notification requirements and their associated notification conditions within a process model. The current invention allows to associate with any portion of a process model notification conditions which then will be monitored by the WFMS; i.e. every level of granularity is supported. Based on this freely definable level of granularity for notifications situations can be avoided wherein too many or too few notifications are sent. This allows on one hand to reduce the number of messages within the network (avoiding overload situations within the network) and on the other hand allows that notifications are still sent if something goes wrong during execution of a process model.

### 3. BRIEF DESCRIPTION OF THE DRAWINGS

FIG. 1 shows a business process model represented by a process graph according to the state of the art.

FIG. 2 depicts a process model of a loan process requiring notification capabilities.

FIG. 3 shows the suggested concept of notifications spheres applied to the example of FIG. 2.

FIG. 4 shows and enhanced example of overlapping notifications spheres.

### 4. DESCRIPTION OF THE PREFERRED EMBODIMENT

In the drawings and specification there has been set forth a preferred embodiment of the invention and, although specific terms are used, the description thus given uses terminology in a generic and descriptive sense only and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which—when being loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The current invention is illustrated based on IBM's “MQSeries Workflow” workflow management system. Of course any other WFMS could be used instead. Furthermore the current teaching applies also to any other type of system, which offers WFMS functionalities not as a separate WFMS but within some other type of system.

4.1 Introduction

The following is a short outline on the basic concepts of a workflow management system based on IBM's “MQSeries Workflow” WFMS:

From an enterprise point of view the management of business processes is becoming increasingly important: business processes or process for short control which piece of work will be performed by whom and which resources are exploited for this work, i.e. a business process describes how an enterprise will achieve its business goals. A WFMS may support both, the modelling of business processes and their execution.

Modelling of a business process as a syntactical unit in a way that is directly supported by a software system is extremely desirable. Moreover, the software system can also work as an interpreter basically getting as input such a model: The model, called a process model or workflow model, can then be instantiated and the individual sequence of work steps depending on the context of the instantiation of the model can be determined. Such a model of a business process can be perceived as a template for a class of similar processes performed within an enterprise; it is a schema describing all possible execution variants of a particular kind of business process. An instance of such a model and its interpretation represents an individual process, i.e. a concrete, context dependent execution of a variant prescribed by the model. A WFMS facilitates the management of business processes. It provides a means to describe models of business processes (build time) and it drives business processes based on an associated model (runtime). The meta model of IBM's WFMS MQSeries Workflow, i.e. the syntactical elements provided for describing business process models, and the meaning and interpretation of these syntactical elements, is described next.

It should however also be noted that process graphs are the typical way of representing business processes in all of these approaches. This gives rise to a first observation: if advanced WFMS modelling constructs within WFMS meta models can be defined by making use of standard process graphs only then it can be assumed that such advanced modeling construct maybe realized in almost any WFMS.

In general a process model can be understood as a multitude of activities as well as rules defining a potential control flow within the process model. In one optional approach such a process model is realized by representing the multitude of activities as nodes of an arbitrary graph and directed edges of said graph are defining a potential control flow within the process model; i.e. above mentioned rules are realized as directed edges within the graph. By choosing the graph oriented implementation possibility in MQSeries business processes are modeled as direct, acyclic, colored, and weighted graphs. The nodes of the graph represent the activities that need to be carried out and the edges of the graph the control connectors that describe the potential sequence in which the activities are to be carried out. Thus a process model is a complete representation of a business process, comprising a process diagram and the settings that define the logic behind the components of the diagram. Important components of an MQSeries Workflow process model are:
Processes
Activities
Blocks
Control Flows
Connectors
Data Containers
Data Structures
Conditions
Programs
Staff

Not all of these elements will be described below.

Activities are the fundamental elements of the meta model. An activity represents a business action that is from a certain perspective a semantic entity of its own.

A MQSeries Workflow process model consists of the following types of activities:

Program activity: Has a program assigned to perform it. The program is invoked when the activity is started. In a fully automated workflow, the program performs the activity without human intervention. Otherwise, the user must start the activity by selecting it from a runtime work list. Output from the program can be used in the exit condition for the program activity and for the transition conditions to other activities.

Process activity: Has a (sub-)process assigned to perform it. The process is invoked when the activity is started. A process activity represents a way to reuse a set of activities that are common to different processes. Output from the process, can be used in the exit condition for the process activity and for the transition conditions to other activities.

The flow of control, i.e. the control flow through a running process determines the sequence in which activities are executed. The MQSeries Workflow workflow manager navigates a path through the process that is determined by the evaluation to TRUE of start conditions, exit conditions, and transition conditions.

Connectors link activities in a process model. Using connectors, one defines the sequence of activities and the transmission of data between activities. Since activities might not be executed arbitrarily they are bound together via control connectors. A control connector might be perceived as a directed edge between two activities; the activity at the connector's end point cannot start before the activity at the start point of the connector has finished (successfully). Control connectors model thus the potential flow of control within a business process model. Default connectors specify where control should flow when the transition condition of no other control connector leaving an activity evaluates to TRUE. Default connectors enable the workflow model to cope with exceptional events. Data connectors specify the flow of data in a workflow model. A data connector originates from an activity or a block, and has an activity or a block as its target. One can specify that output data is to go to one target or to multiple targets. A target can have more than one incoming data connector.

Process definition includes modelling of activities, control connectors between the activities, input/output container, and data connectors. A process is represented as a directed acyclic graph with the activities as nodes and the control/data connectors as the edges of the graph. The graph is manipulated via a built-in graphic editor. The data containers are specified as named data structures. These data structures themselves are specified via the DataStructureDefinition facility. Program activities are implemented through programs. The programs are registered via the Program Definition facility. Blocks contain the same constructs as processes, such as activities, control connectors etc. They are however not named and have their own exit condition. If the exit condition is not met, the block is started again. The block thus implements a Do Until construct. Process activities are implemented as processes. These subprocesses are defined separately as regular, named processes with all its usual properties. Process activities offer great flexibility for process definition. It not only allows to construct a process through permanent refinement of activities into program and process activities (top-down), but also to build a process out of a set of existing processes (bottom-up).

All programs, which implement program activities, are defined via the Program Registration Facility. Registered for each program is the name of the program, its location, and the invocation string. The invocation string consists of the program name and the command string passed to the program.

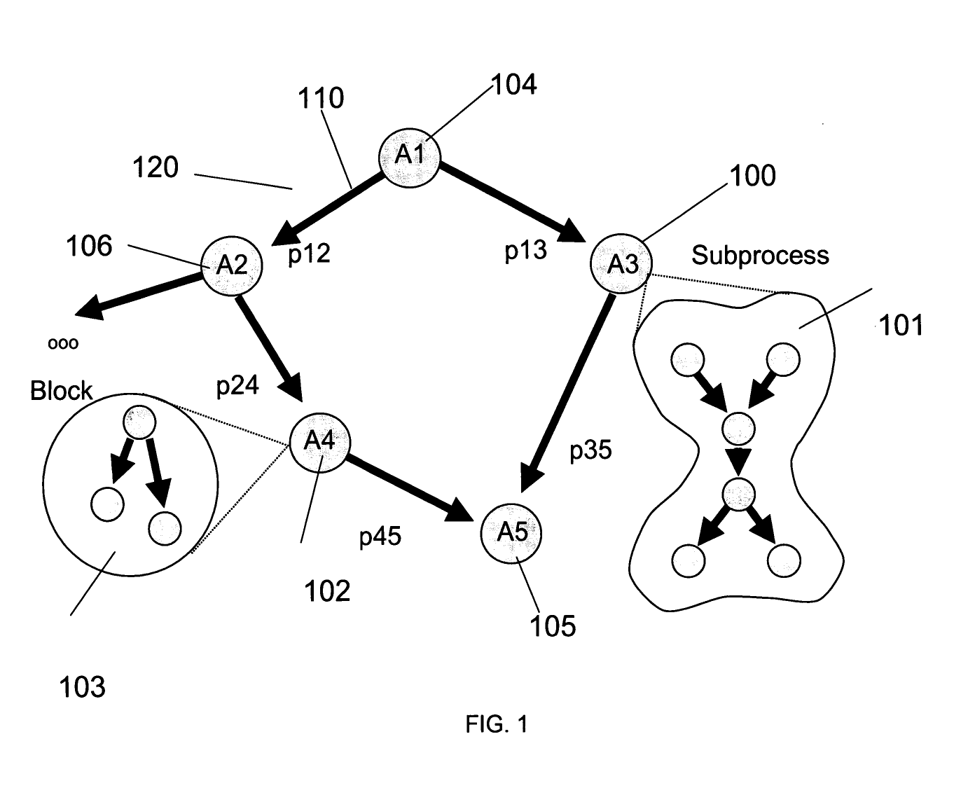

As an example of such a process model FIG. 1 shows schematically the structure of such a process graph. Activities (A1 up to A5) are represented as named circles; the name typically describes the purpose of the activity. Activities come in various flavors to address the different tasks that may need to be performed. They may have different activity implementations to meet these diverse needs. Program activities are performed by an assigned program, process activities like for instance 100 are performed by another process 101, and blocks like for instance 102 implement a macro 103 with a built-in do-until loop. Control connectors p12, p13, p24, p35, p45 are represented as arrows; the head of the arrow describes the direction in which the flow of control is moving through the process. The activity where the control connector starts is called the source activity; where it ends is called the target activity. When more than one control connector leaves an activity, this indicates potentially parallel work.

In general the activities, for example 104, 100, 106, 102, 105, describe the tasks to be performed and the control connectors, for example 110 describe the potential sequence in which the activities are to be carried out. Control connectors are asscoiated with transition conditions, for example 120; a control connector is only followed if the transition condition (arbitrary complex Boolean predicates) evaluates to TRUE.

4.2 Notification Within Workflow Management Systems

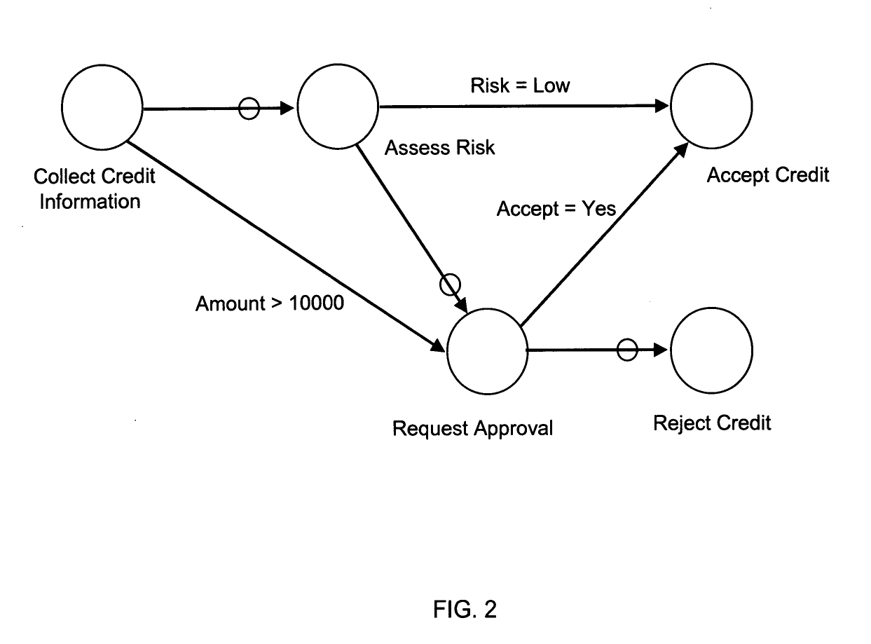

FIG. 2 shows a typical business process, a loan process, where certain activities or even the complete process must be completed in time, and if not, that some person should be notified. The usual notation has been used to depict the process model graphically: activities are represented by circles, control connectors by directed arcs, transition conditions by boxes comprising some Boolean predicate attached to the arcs.

To specify in MQSeries Workflow using the MQSeries Workflow proprietary language FDL (Flow Definition Language) that this example process should complete in 10 days and if not that the process administrator should be notified a specific language construct is provided to be included within the process model.

This is identified via the NOTIFICATION keyword. For the given example it could be defined in the following manner:

PROCESS LoanProcess
NOTIFICATION AFTER 10 DAYS
END LoanProcess

Since no designated person is specified, the process administratior receives the notification. This approach allows to define the notification only for the process model as a whole.

The only other possible alternative is to define notifications for each individual activity. An example for the corresponding language construct illustrating an appropriate notification on the activity level it is given below. Within this example the first notification is sent out after 5 days; since no person is specified, it is sent to the manager of the person to whom the activity was assigned. If the activity is still not completed after 3 days (as indicated via the SECOND_NOTIFICATION keyword), another notification is sent out. Thus the example satisfying these conditions could be specified in the following manner:

```
ACTIVITY RequestApproval
    NOTIFICATION AFTER 5 DAYS
        SECOND_NOTIFICATON AFTER 3 DAYS
END RequestApproval
```

Since no person is specified, the notification is sent to the process administrator.

4.3 Notifications Spheres Within A Workflow Management Systems

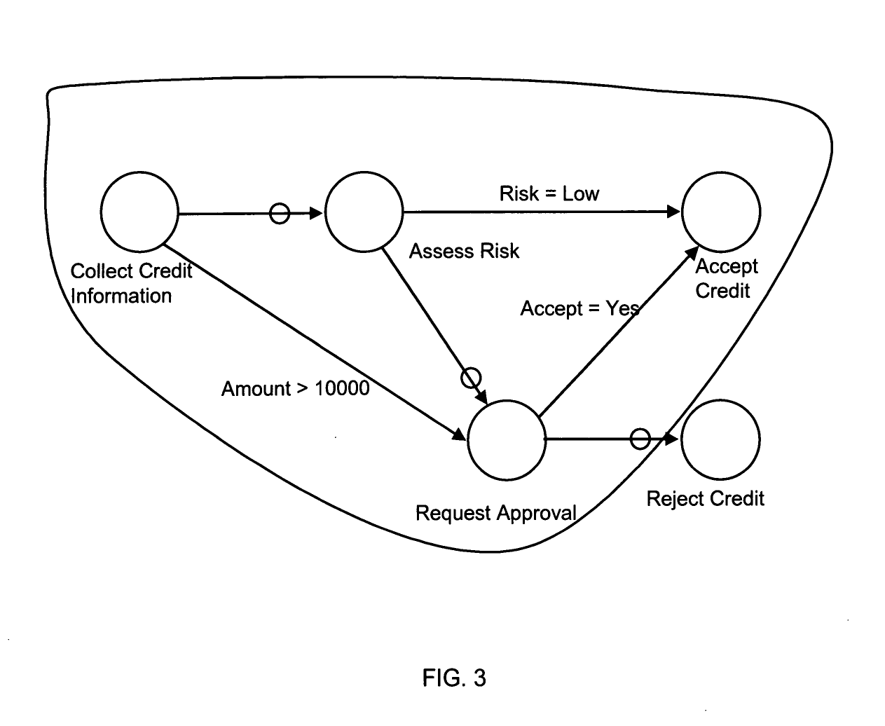

As apparent from these examples the specification of the notification condition (in these cases a notification period) is done on an activity level or on a process level only; other possibilities do not exist. Sometimes however it is desireable to have this specification capability also for a sub-set of activities comprised within the process model. FIG. 3 illustrates such a case for the example of FIG. 2; one would like to specify that all accepted loan applications should be processed in a specified time period. This piece of the process is highlighted in FIG. 3 via a shaded area; it comprises the activities labeled “Collect Credit Information”, “Assess Risk”, “Request Approval”, “Accept Credit”. When this piece of the process is not completed in a specified time, then one would like to inform a particular person about this situation so that appropriate actions can be taken. We call this piece of the process a notification sphere.

This desired behavior, that means that one can define a notification sphere and associate notification specifications with said sphere, cannot be expressed using the NOTIFICATION keyword for each of the activities.

The only alternative way to “approximate” this behavior is by replacing the four activities with a process activity, creating a process that consists of the four original activities, and then assign the NOTIFICATION keyword to the process activity to specify the time the sub-process, that means the four activities should take. It has to be noted that not only this solution works only in some, certainly not in all, cases, but the solution is rather artifical for several reason:
The process modeler must create a sub process.
The transition conditions are completely different from the original intent.
The audit trail that is written reflects this process model structure.

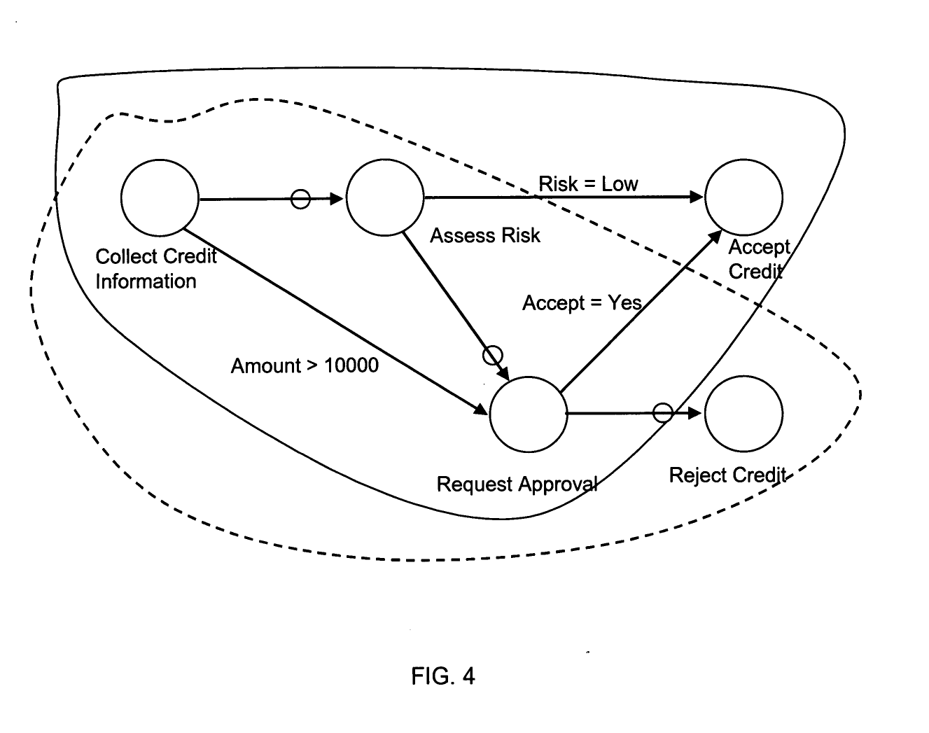

Moreover this alternative solution approach can not be used at all, if one would like to have different overlaping notification spheres as shown in FIG. 4. One notification sphere (the one with the solid line) includes all activities which may be carried out when the loan is granted; the other notification sphere (the one with the dashed line) includes all activities which may be carried out when the loan is denied.

Thus, according to the current invention the specified problem can be solved by making notification spheres part of the workflow management system metamodel; then notifications spheres can be specified within the process model of a business process. FIG. 3 illustrates how such a notification sphere could be defined for the process shown in FIG. 2. The following illustrates how a notification sphere can be defined using the Flow Definition Language extended by appropriate keywords:

```
PROGRAM_ACTIVITY CollectCreditInformation
END CollectCreditInformation
PROGRAM_ACTIVITY AssessRisk
END AssessRisk
PROGRAM_ACTIVITY RequestApproval
END RequestApproval
PROGRAM_ACTIVITY AcceptCredit
END AcceptCredit
NOTIFICATION_SPHERE
    NOTIFICATION AFTER 5 DAYS
        TO PROCESS_ADMINISTRATOR
    RELATED_ACTIVITY CollectCreditInformation
    RELATED_ACTIVITY AssessRisk
    RELATED_ACTIVITY RequestApproval
    RELATED_ACTIVITY AcceptCredit
END
```

The NOTIFICATION_SPHERE keyword starts the definition of a notification sphere. The RELATED_ACTIVITY keyword followed by the name of an activity causes the named activity to become part of the notification sphere. The NOTIFICATION keyword has the standard meaning; the AFTER keyword is used to specify the time after which notification should take place; the TO keyword is used to specify to whom the notification should be sent to.

4.3 Processing Notifications Spheres By A Workflow Management Systems

Given the capabilities within a process model to specify notifications spheres the following describes how these specifications are handled by the WFMS when controlling execution of a process instance of a process-model of a business-process:
1. In a first step the WFMS determines whether the process model comprises a specification defining a notification sphere according to the terminology above; i.e. a notification-sphere comprises a sub-graph of the arbitrary graph of activities making up the process model. Moreover it is determined whether the notification sphere is associated with at least one predefined notification condition. A notification condition is understood to specify a condition under which a notification is to be sent on behalf of activities comprised the activities within the notifications sphere. The notification condition could be any type of condition, for instance expressed in terms of arbitrary complex Boolean predicates. In standard cases the notification condition relates to an expected point in time when the notification sphere should be completed.
2. In a second step the WFMS starts monitoring of the notification condition once the control flow entered the notification sphere the first time.
3. In a third step the WFMS sends on behalf of the activities comprised by the sub-graph a notification once the notification condition is fulfilled.
4. In a fourth step the WFMS stops monitoring the notification condition if the control flow leaves the notification sphere and none of the activities within the notification sphere has control anymore.

In case the specification of the notification sphere comprises at least one addressee the notification is to be sent to, the WFMS takes responsibility to send the notification to exactly this addressee.

In the standard case the notification condition comprises the specification of a completion time, and which defines the point in time the corresponding notification sphere should be completed. This completion time could be the specification of a absolute point in time. Alternatively the completion time could also be specified in relative terms. Another advantage could be that the completion time specification is specified in time units measure from the time the control-flow entered the notification-sphere the first time.

1. A computerized method for handling of notifications within a Workflow Management System or a computer system with comparable functionality (WFMS),
said WFMS controlling execution of a process-instance by interpreting the instance of a process-model of a business-process, and
said process-model comprising a multitude of activities and further comprising rules defining a potential control-flow within said process-model, and
said method comprising:
a step of determining if said process-model comprising a specification defining a notification-sphere,
said notification-sphere comprises a multitude of activities representing a proper subset of activities of said process model, and
said notification-sphere is associated with at least one predefined notification-condition, specifying a condition under which a notification is to be sent on behalf of activities comprised by said subset of activities, and
a step of starting monitoring said notification-condition once control-flow entered said notification-sphere a first time, and
a step of sending on behalf of said activities comprised in said notification-sphere a notification once said notification-condition is fulfilled.

2. The computerized method for handling of notifications according to claim 1,
wherein said method comprising a step of stopping monitoring said notification-condition if control-flow left said notification-sphere and none of activities within said notification-sphere has control anymore.

3. The computerized method for handling of notifications according to claim 1,
wherein said specification defining said notification-sphere comprising at least one addressee said notification is to be sent to, and
wherein said step of sending is sending said notification to said addressee.

4. The computerized method for handling of notifications according to claim 1,
wherein said notification-condition is comprising a completion-time specification specifying a point in time said notification-sphere should be completed.

5. The computerized method for handling of notifications according to claim 4,
wherein said completion-time specification is specified in time-units measure from the time the control-flow entered said notification-sphere the first time.

6. A computer system comprising means adapted for carrying out the steps of the method according to claim 1.

7. A data processing program for execution in a data processing system comprising software code portions for performing a method according to claim 1 when said program is run on said data processing system.

8. A computer program product stored on a computer usable medium, comprising computer readable program means for causing a computer to perform a method according to claim 1 when said program is run on said computer.
